(19) United States
(12) Patent Application Publication
(10) Pub. No.: US 2023/0113418 A1
(43) Pub. Date: Apr. 13, 2023

(54) CONTAINER

(71) Applicant: HMS Mfg. Co., Troy, MI (US)

(72) Inventors: Janet M. Sofy, Troy, MI (US); Todd Kemmer, Clarkston, MI (US)

(21) Appl. No.: 17/965,269

(22) Filed: Oct. 13, 2022

Related U.S. Application Data
(60) Provisional application No. 63/255,040, filed on Oct. 13, 2021.

(51) Int. Cl. B65F 1/08; B65F 1/16

(52) U.S. Cl. CPC B65F 1/08; B65F 1/163

(57) ABSTRACT

A container for holding items, such as waste, is provided. The container includes a body which can be formed of plastic or metal, such as stainless steel, or other materials, and includes walls defining an inner chamber. A pivotable lid is connected to the body. A trim ring rests on a top edge of the body which is rolled outward away from the inner chamber. The trim ring is pivotable between a down position and an up position. A removable tray is disposed in the inner chamber, and a collar having a ring shape is disposed along a base of the container and between the removable tray and the body to support a periphery of the removable tray. The removable tray and the top edge of the body define a clearance space therebetween when the removable tray is raised from the base and out of the container.

### CROSS REFERENCE TO RELATED APPLICATIONS

This U.S. utility patent application claims the benefit of U.S. provisional patent application No. 63/255,040, filed Oct. 13, 2021, the entire contents of which are incorporated herein by reference.

### BACKGROUND OF THE INVENTION

### 1. Field of the Invention

The present invention relates to a container for holding and transporting items, such as waste.

### 2. Related Art

Containers made of plastic, metal, such as stainless steel, or other materials are oftentimes used to store waste or other household items. Containers, especially those designed for containing waste and for household use, oftentimes include a lid attached to a body of the container, and the lid pivots between an open and closed position. These containers may or may not include a foot pedal. In embodiments which include the foot pedal, when pressure is applied to the foot pedal by a user, the lid pivots from the closed position to the open position. The body of the container is typically designed to contain a plastic bag for retaining the waste or other items. An uppermost portion of the bag drapes over a rim of the body of the container. The bag may include a drawstring, or the container can include some type of retaining mechanism to retain the bag in position. Examples of containers are disclosed in U.S. Pat. Nos. 8,066,144 and 10,279,997, as well as U.S. Patent Application Publication Nos. 2006/0226302, 2009/0261105, and 2020/0407159.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a perspective view of a container according to a first example embodiment;

FIG. 2 is an exploded view of the container according to the first example embodiment;

FIG. 3 is a perspective view of a portion of the container according to the first example embodiment;

FIG. 4 is a cross-sectional fragmentary view of a rim assembly of the container of the first example embodiment;

FIG. 5 is a cross-sectional fragmentary view of a connecting portion of a trim ring of the container according to the first example embodiment;

FIG. 6 is a perspective view of a base of the container according to the first example embodiment;

FIG. 7 is a cross-section view of the base of the container according to the first example embodiment;

FIG. 8 is a perspective view of a container according to a second example embodiment;

FIGS. 9A-9C are cross-sectional fragmentary view of a base of the container according to the second example embodiment;

FIG. 10 is a cross-sectional fragmentary view of a rim assembly of the container of the second example embodiment;

FIGS. 11A-11F are perspective view of the container including a removable tray according to the second example embodiment;

FIGS. 12A-12D are cross-sectional side views showing the removable tray and a collar according to the second example embodiment;

FIG. 13 is an exploded view of the container according to the second example embodiment;

FIG. 14 is a perspective view of a base of the container according to the second example embodiment;

FIG. 15 is a perspective view of a portion of the container including the lid according to the second example embodiment;

FIG. 16 is a side cross-section view of a portion of the container including the lid according to the second example embodiment; and

FIG. 17 is a side cross-section view of a portion of the container including a damper according to another example embodiment.

### DESCRIPTION OF EXAMPLE EMBODIMENTS

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that none should be construed to limit the scope of the disclosure. In some example embodiments, well-known processes, well-known device structures, and well-known technologies are not described in detail.

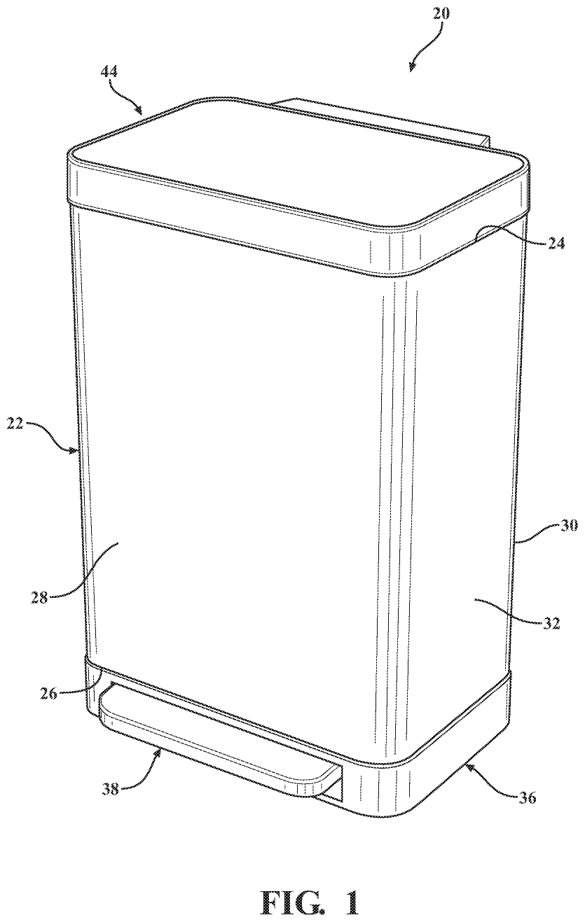

A container 20 for holding items, such as waste, according to a first example embodiment is illustrated in FIGS. 1-7. The container 20 includes a body 22 extending between a top edge 24 and a bottom edge 26 and including a front wall 28 and a back wall 30 interconnected with parallel side walls 32. The body 22 can be formed of plastic, metal, or another material, for example stainless steel. The walls 28, 30, 32 of the body 22 define an inner chamber for containing trash or other items.

The top edge 24 and the bottom edge 26 of the body 22 roll inward toward the inner chamber. A base 36 is connected to the bottom edge 26 of the body 22. A lid assembly 44, including a lid 46 and a trim ring 48 is connected to the top edge 24 of the body 22 for selectively covering the inner chamber 34.

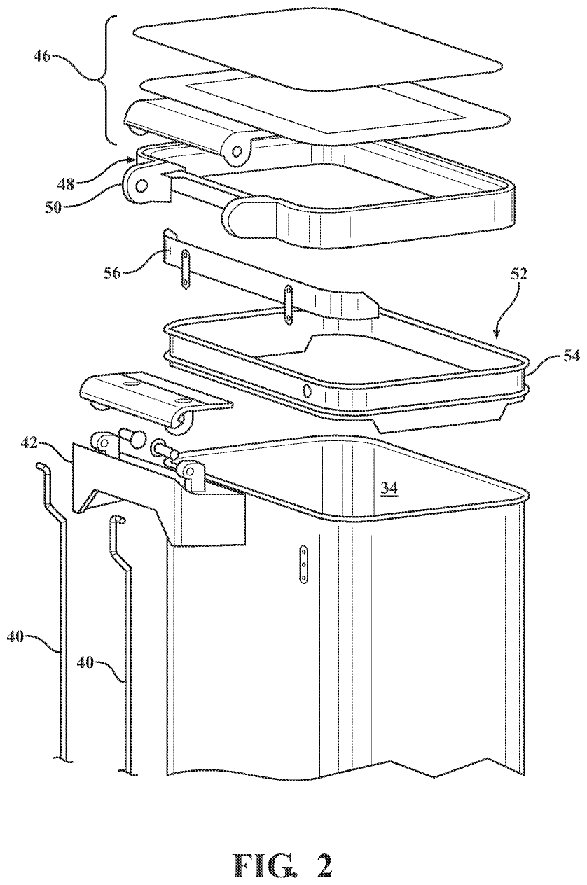

As shown in the example embodiments of FIGS. 1 and 2, a pedal assembly 38 is disposed in the base 36, and at least one rod 40 extends between the pedal assembly 38 and the lid 46. However, according to alternate embodiments, the container 20 does not include a pedal assembly 38. As shown in the example of FIG. 2, a projection 42 extends outwardly from the back wall 30 to provide a gripping area for manipulating the container 20. The lid 46 and the trim ring 48 each includes a connecting portion 50 for engaging the projection 42. The lid 46 is pivotable between a closed position and an open position when a user engages the pedal assembly 38, and the trim ring 48 is pivotable between a down position and an up position. A rim assembly 52 is mounted to the top edge 24 of the body 22 for supporting the open end of a bag disposed in the inner chamber 34.

As shown in FIGS. 1 and 2, the rim assembly 52 includes a first rim portion 54 and a second rim portion 56 for ease of assembly. The first rim portion 54 has an annular shape and includes an upper band 58 and a lower band 60 interconnected by a lower lip 62 extending radially outwardly from the first rim portion 54. The upper band 58 extends vertically upwardly from the lower lip 62 to an upper lip 64 that extends radially outwardly from the upper band 58. The lower band 60 extends downwardly at an oblique angle toward the front wall 28 and the side walls 32 of the body 22 to engage the body 22. The oblique angle obviates need for a liner and provides for easy removal of the trash bag.

A plurality of ribs 66 extend radially outwardly to engage the top edge 24 of the body 22 for securing the rim to the body 22. One of the ribs 66 is shown in FIG. 4. The top edge 24 of the body 22 is sandwiched between the plurality of ribs 66 and the lower lip 62. When the trash bag is disposed in the inner chamber 34, the open end of the bag is pulled along an outer surface of the upper band 58. The upper band 58 defines a circular slot 68 for receiving excess trash bag. The second rim portion 56 is affixed to the back wall 30 of the body 22 with a plurality of securing members 70, such as screws. The second rim portion 56 mates with the first rim portion 54 to form a part of the lower band 60 along the back wall 30 of the body 22.

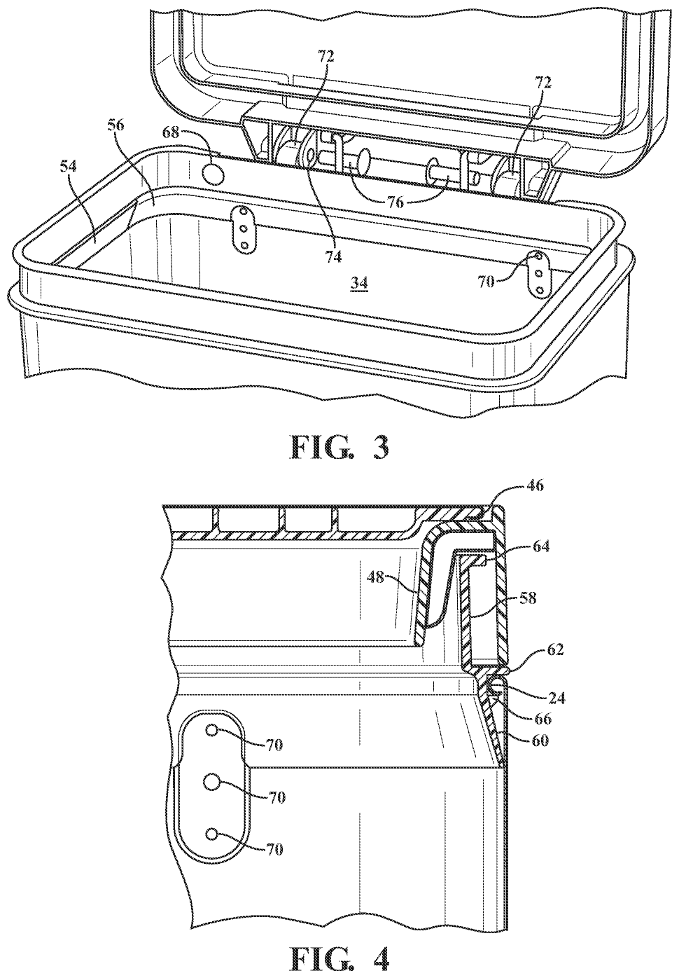

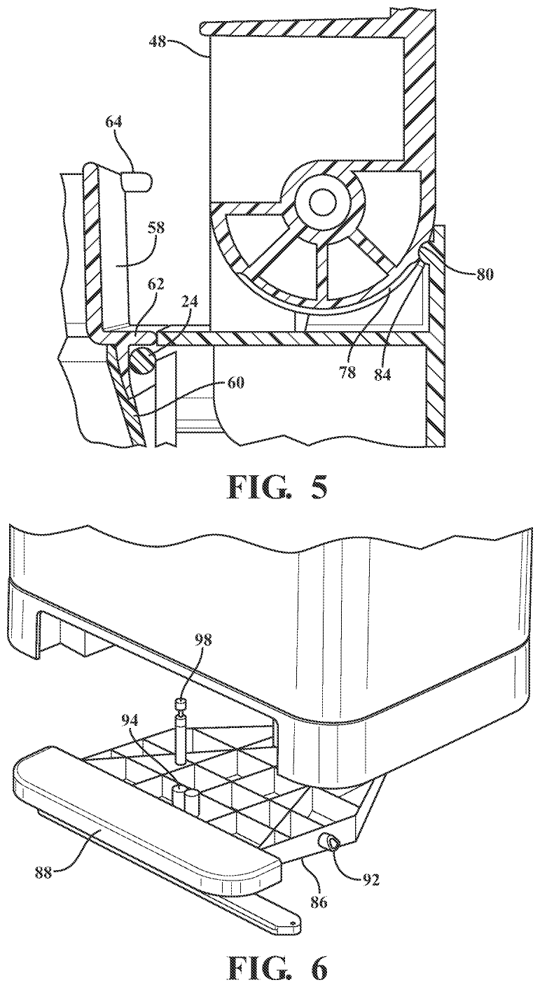

The projection 42 extending outwardly from the back wall 30 of the body 22 also includes a pair of female hinge members 72 to provide pivotable connection to the lid assembly 44. The connecting portions 50 of the trim ring 48 and the lid 46 each defines a pair of holes 74 aligned with one another and with the pair of female hinge members 72. As shown in FIG. 3, a dowel 76 engages the holes 74 and the pair of female hinge members 72 to allow the lid 46 and trim ring 48 to rotate about a common axis of rotation. The trim ring 48 defines a groove 78 and a notch 80 extending into a connecting portion 50 of the trim ring 48. As shown in FIG. 5, a bump 84 extends outwardly from the projection 42 for engaging the groove 78 while the trim ring 48 is in motion and for engaging the notch 80 when the lid 46 is held in the raised position.

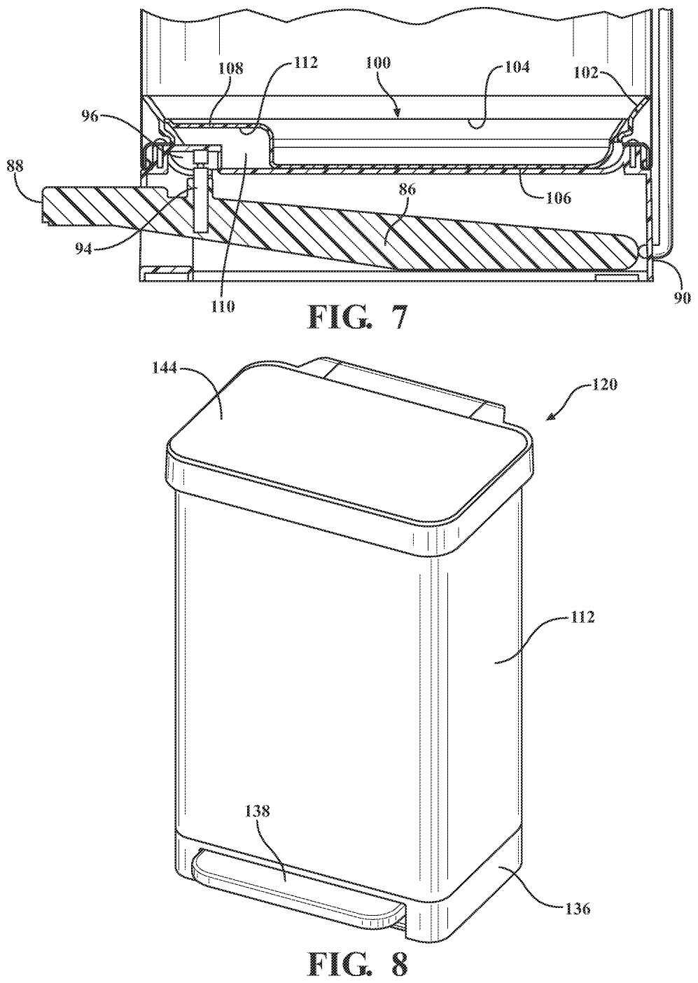

As shown in FIGS. 6 and 7, the pedal assembly 38 includes a pedal 86 disposed in the base 36 extending between a front end 88 and a back end 90 with the front end 88 extending outwardly from the base 36. The pedal 86 includes a pair of axles 92 that pivotally engages the base 36 and allows the pedal 86 to rotate between a resting position and an actuated position. In the resting position, the front end 88 of the pedal 86 is disposed adjacent to the bottom edge 26 of the body 22. In the actuated position, the front of the pedal 86 is spaced from the bottom edge 26 of the body 22 due to a downward force applied to the front end 88 of the pedal 86 via, for example, a user's foot.

The pedal 86 defines a lower recess 94 near the front of the pedal 86, and the base 36 defines an upper recess 96 disposed above the lower recess 94. An oil damper 98 is received in and extends between the upper recess 96 and the lower recess 94 for dampening the rate at which the pedal 86 moves from the actuated position to the resting position. In operation, when the pedal 86 is moved toward the actuated position, the back end 30 of the pedal 86 pushes the at least one rod 40 upwardly, thereby pushing the lid 46 to the open position.

As illustrated in FIG. 7, a removable tray 100 is disposed at the bottom edge 26 of the body 22 and bounds the inner chamber 34. The tray 100 provides for holding excess refuse or other items that escape the trash bag. A collar 102, having a ringed shape, is secured to the base 36 and engages the walls 28, 30, 32 of the body 22 for supporting a tray 100 along a periphery 104 of the tray 100. The tray 100 has a lower portion 106 having a generally flat rectangular shape and raised portion 108 disposed adjacent a portion of the periphery 104. The raised portion 108 defines a hollow 110 between the tray 100 and the base 36. The hollow 110 is accessible, for example by a user's finger via a through-hole 112 defined by the raised portion 108 to allow the tray 100 to be removed from the inner chamber 34 for cleaning. Alternatively, the hollow 110 can be accessible by another means.

There are several aspects of the container 20 which are significantly different and provide advantages over comparative designs, such as those of the prior art. For example, container 20 includes the removable tray 100 having a through-hole 112 defined by the raised portion 108 and defining a hollow 110 between the tray 100 and the base 36. The container 20 also includes the rim assembly 52 having the upper lip 64 extending radially outwardly from the upper band 58 for allowing the open end of the bag to be held along the outer surface of the upper band 58. Another significant aspect of the container 20 is the arrangement of the collar 102 engaging the walls 28, 30, 32 of the body 22 for supporting the tray 100, with the tray 100 being separate from the collar 102. This arrangement allows the tray 100 to be lifted out of the inner chamber 34 without disassembly of the container 20. Another notable feature of the container 20 is the arrangement of the first rim portion 54 and the second rim portion 56, wherein the first rim portion 52 mates with the second rim portion 56 to form a part of the lower band 60 along the back wall 30 of the body 22 and the second rim portion 56 is affixed to the back wall 30 of the body 22 via a plurality of securing members 70. This arrangement provides for ease of assembly of the container 20.

The container 120 according to a second embodiment is shown in FIGS. 8-16. The container 120 of the second embodiment includes most of the features of the first embodiment, except with updates to the specific design. A perspective view of the container 120 according to the second example embodiment is shown in FIG. 8.

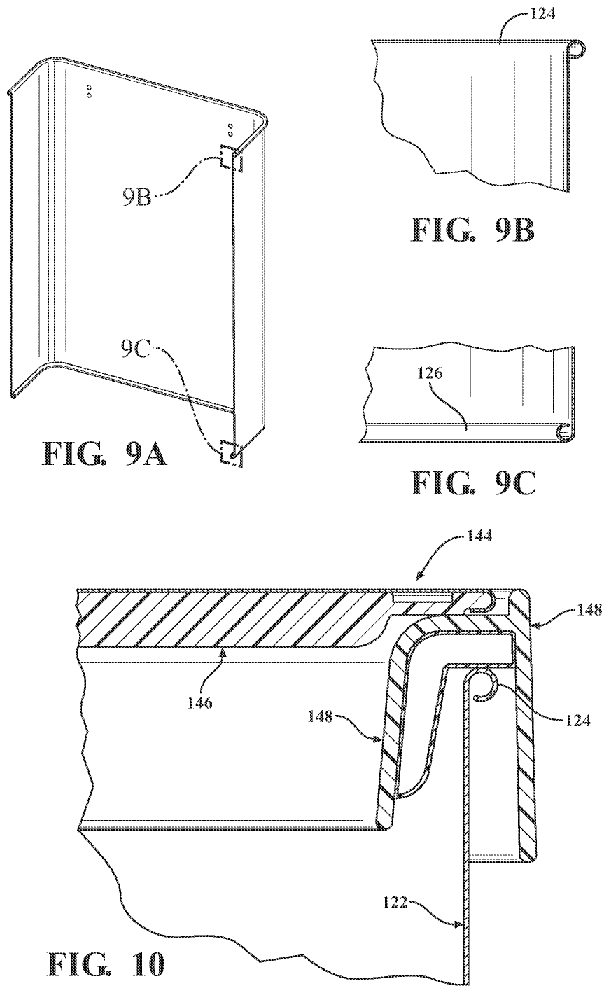

The container 120 according to the second embodiment also includes the body 122 defining the inner chamber for containing trash or other items. However, as shown in FIGS. 9A-9C and unlike the container 20 of the first embodiment, the top edge 124 of the body 122 rolls outward away from the inner chamber. The bottom edge 126 of the body 122 rolls inward. A base 136 is connected to the bottom edge 126 of the body 122, and a lid assembly 144, rests on the top edge 124 of the body 122 for selectively covering the inner chamber. Like the first embodiment, a pedal assembly 138 including a pedal 186 is disposed in the base 136.

As shown in FIG. 10, the container 120 according to the second embodiment includes an improvement in the design of the ring assembly. The first rim portion 54 (including the upper band 58, lower band 60, lower lip 62, and upper lip 64) is removed, and the trim ring 148 rests directly on the top edge 124 of the body 122. The lid 146 rests directly on the trim ring 148. The trash bag can thus be secured between the trim ring 148 and the top edge 124 of the body 122. The trim ring 148 includes the connecting portion 150, as in the first example embodiment.

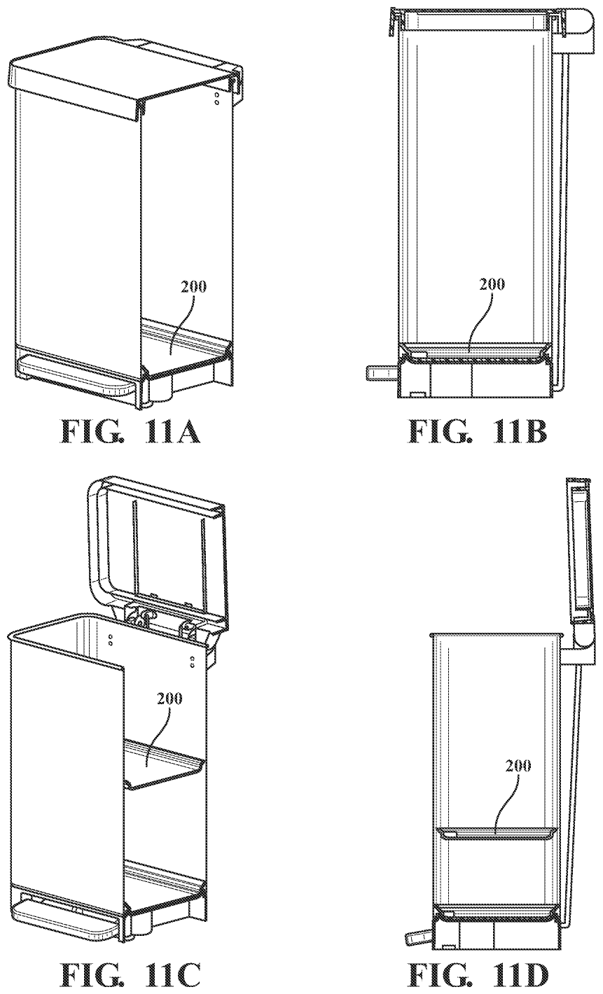

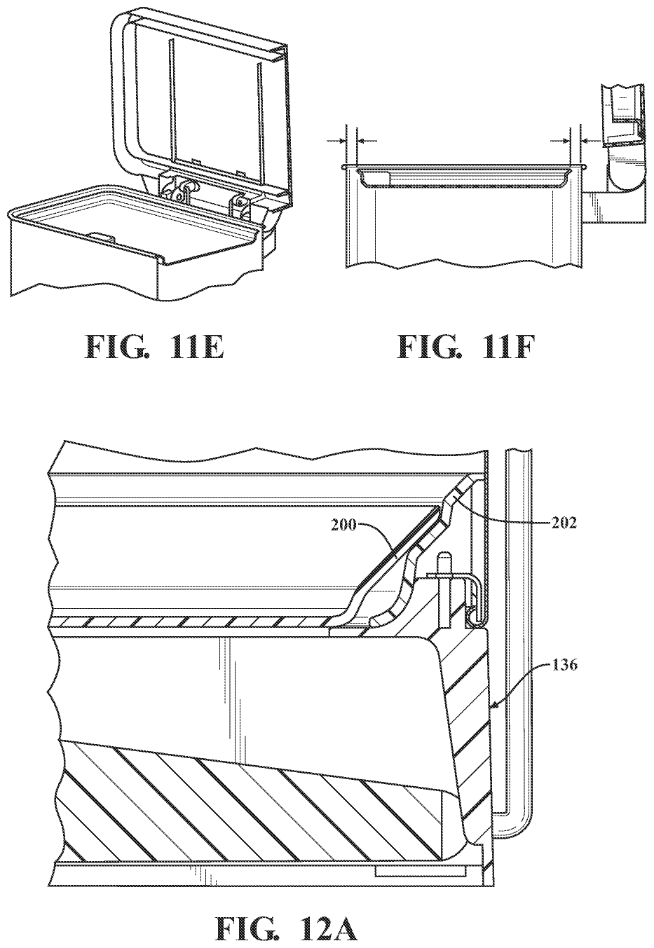

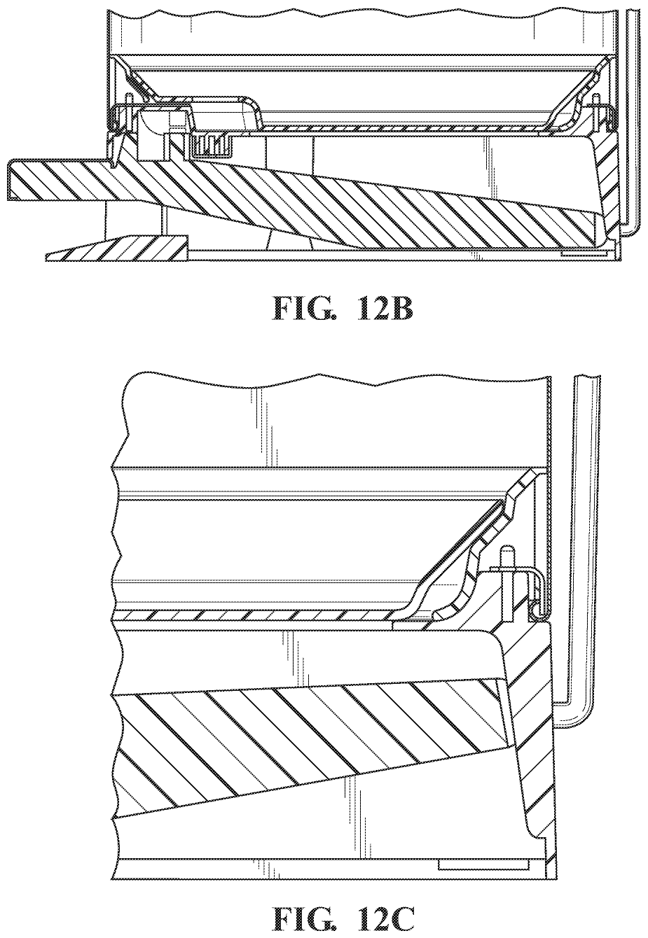

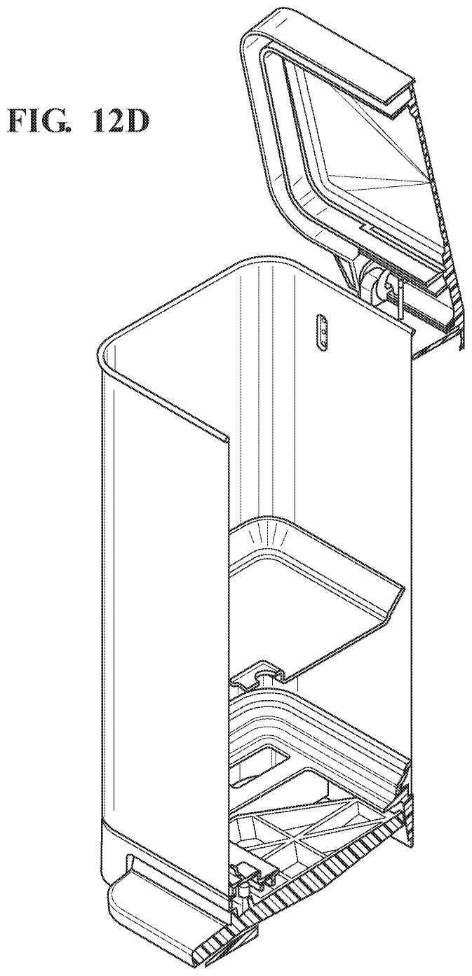

The container 120 according to the second embodiment also has improvements related to the removable tray 200. As shown in FIGS. 11A-11F, the geometry of the removable tray 200 is changed to create more clearance between the body 122 and the tray 200 when removing the removable tray 200 from the body 122. As shown in FIGS. 12A-12D, the geometry of the overlapping areas of the removable tray 200 and collar 202 is also updated to improve the flow of any fluid down the walls of the body 122, onto the collar 202, and finally into the removable tray 200. The oil damper 198 is included for dampening the rate at which the pedal 186 moves from the actuated position to the resting position.

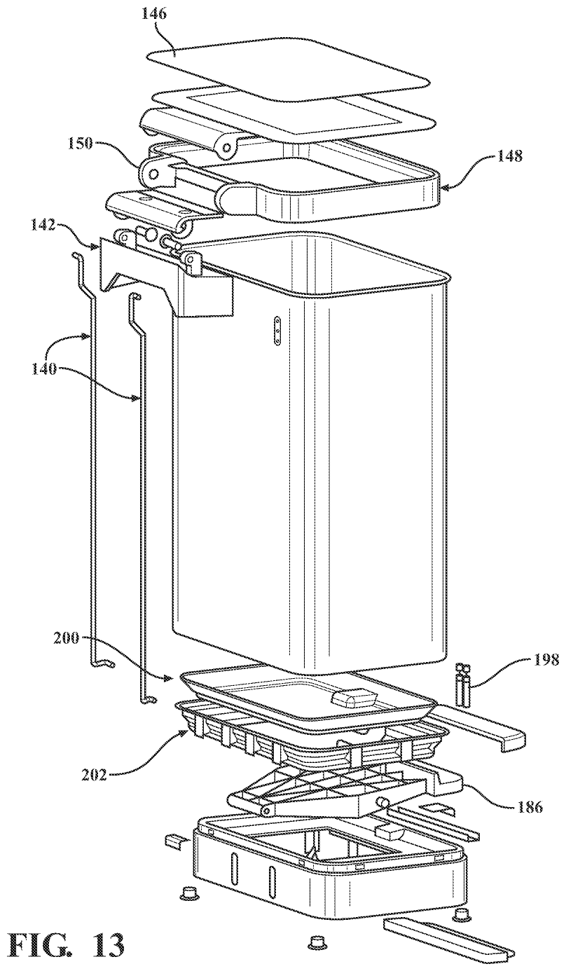

FIGS. 13-16 are additional views of the container 120 according to the second embodiment. FIG. 13 includes an exploded view of the container 120. As shown in FIG. 13, the container 120 of the second embodiment includes the at least one rod 140 extending between the pedal 186 and the lid assembly 146. The projection 142 is connected to and extends outwardly from the body 122 to provide a gripping area for manipulating the container 120. The lid assembly 146 and the trim ring 148 are connected to the projection 142.

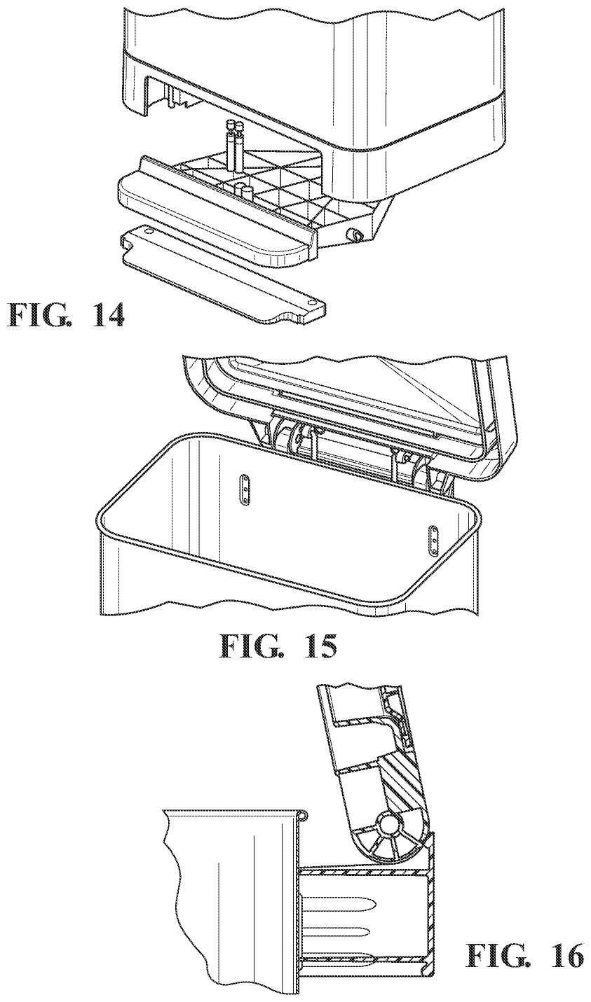

FIG. 14 is a perspective view of the base 136 of the container according to the second example embodiment. FIG. 15 is a perspective view of a portion of the container 120 including the lid assembly 146 according to the second example embodiment; and FIG. 16 is a side cross-section view of a portion of the container including the lid assembly 146 according to the second example embodiment.

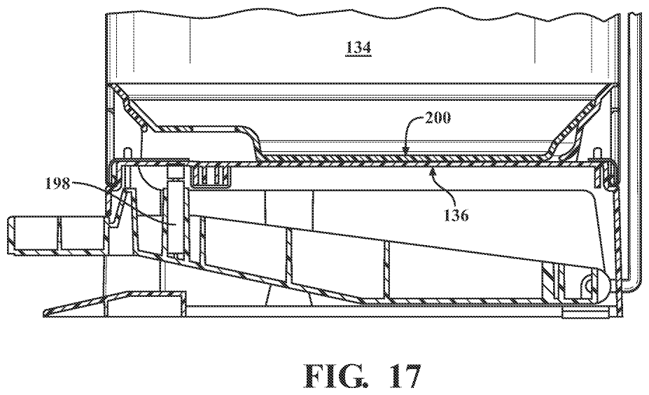

FIG. 17 is a side cross-section view of a portion of the container 120 including the damper 198 according to another example embodiment. This design can be used in the container according to the first embodiment (the container 20) or the second embodiment (the container 120), but preferably the container 120 of the second embodiment. As shown in FIG. 17, the damper 198 is located completely beneath the base 136, completely beneath the removable tray 200, and thus completely beneath the inner chamber 134. The damper 198 engages an underside of the base 136 when actuated by the pedal 186.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. A container, comprising:
a body defining an inner chamber;
a lid connected to the body and being pivotable between an open position and a closed position;
a removable tray disposed in the inner chamber of the body;
a collar disposed along the base and between the removable tray and the body;
the collar supporting a periphery of the removable tray;
the removable tray and the body defining a clearance space therebetween when the removable tray is raised to adjacent a top edge of the body.

2. The container according to claim 1 including a trim ring resting on a top edge of the body.

3. The container according to claim 2, wherein the trim ring is pivotable between a down position and an up position.

4. The container according to claim 1, wherein a top edge of the body is rolled outward away from the inner chamber.

5. The container according to claim 1, wherein at least one rod extends between the pedal assembly and the lid for pivoting the lid when the pedal assembly is engaged.
